(19) United States
(12) Patent Application Publication
(10) Pub. No.: US 2022/0250351 A1
(43) Pub. Date: Aug. 11, 2022

(54) MULTILAYER FIRE EXTENSION RESISTANT AND FIRE PROTECTION STRUCTURE MANUFACTURED BY INJECTION MOLDING

(71) Applicant: NYTEX COMPOSITES CO., LTD, Pitou Township (TW)

(72) Inventor: HSUN SEN CHEN, Pitou Township (TW)

(21) Appl. No.: 17/533,219

(22) Filed: Nov. 23, 2021

(30) Foreign Application Priority Data
Feb. 5, 2021 (TW) 110201437

(51) Int. Cl. B32B 7/027; B32B 3/30; B32B 5/02; B32B 27/12; B32B 27/34; B32B 27/22; C08K 13/02

(52) U.S. Cl. CPC B32B 7/027; B32B 3/30; B32B 5/022; B32B 5/024; B32B 27/12; B32B 27/34; B32B 2307/3065; C08K 13/02; B32B 2250/03; B32B 2250/40; B32B 2262/101; B32B 2262/106; B32B 2262/105; B32B 27/22

(57) ABSTRACT

A multilayer fire extension resistant and fire protection structure manufactured by injection molding includes a support layer composed of a porous fiber fabric and having a first face and a second face opposite to the first face, and two fire retardant layers each composed of a thermoplastic fire retardant polymer material. The two fire retardant layers are injection molded to respectively cover at least the first face and the second face of the support layer.

### BACKGROUND

The present invention relates to a fire protection structure and, more particular, to a multilayer fire extension resistant and fire protection structure manufactured by injection molding.

Fiber composite materials have good mechanical properties, such as high strength and low density, and are widely used in aerospace, railways, machinery manufacturing, construction and other fields. Further, making fiber composite materials have fire retardancy, thereby preventing fire extension, is an important development direction of fire protection fiber composite materials.

Inorganic compounds are generally more fire resistant materials than organic compounds. Therefore, a multilayer structure composed of inorganic compounds and organic compounds mostly uses an inorganic compound layer facing the fire source to achieve the purpose of fire prevention.

Most common multilayer fire protection structures are formed by hot-press thrilling. Thus, complex structural designs such as reinforcing ribs and screw posts cannot be formed, which greatly limits the scope and conditions of their applications. The other multilayer fire protection structures use thermosetting composite materials coating on inorganic plates such as calcium silicate plates and stainless steel plates, flame burnthrough is thereby avoided via the fireproof properties of inorganic, plates, but thermosetting materials cannot be recycled and reused, causing the environment burden.

Thus, a need exists for a novel fire protection structure to mitigate and/or obviate the above disadvantages.

### SUMMARY

A multilayer fire extension resistant and fire protection structure according to the present invention includes a support layer and two fire retardant layers. The support layer is formed of a porous fiber fabric and has a first face and a second face opposite to the first face. The two fire retardant layers each are formed of a thermoplastic fire retardant polymer material, and the two fire retardant layers are injection molded to respectively cover at least the first face and the second face of the support layer.

Preferably, the thermoplastic fire retardant polymer material is a semi-crystalline thermoplastic polymer composite or a non-crystalline thermoplastic polymer composite.

Preferably, the porous fiber fabric is at least one or a combination selected from the group comprising: a staple fiber cloth, a long fiber cloth, a woven fiber cloth, a non-woven cloth, a unidirectional fiber cloth, and a multiaxial multilayer fabric.

Preferably, the porous fiber fabric has a mesh number of 100-5000.

Preferably, the porous fiber fabric is formed of at least one or a combination selected from the group comprising: a graphite fiber, a graphene fiber, a carbon fiber, a glass fiber, a ceramic fiber, a boron nitrogen fiber, a silicon nitride fiber, a mineral salt fiber, an aromatic polyamide fiber, and an aramid synthetic fiber.

Preferably, the thermoplastic fire retardant polymer material comprises: 25-45% weight percent of a polyamide; 0.1-2.0% weight percent of a lubricant; 0.1-2.0% weight percent of an antioxidant; 0.1-2.0% weight percent of a surfactant; 0.1-20% weight percent of a toughener; 5-40% weight percent of a nontoxic fire retardant; 10-45% weight percent of a reinforcement modifier; and 0-20% weight percent of a reinforcing material.

The multilayer fire extension resistant and fire protection structure manufactured by injection molding, which satisfies the standard of UL94/5VA.

In an embodiment, one side of at least one of the two fire retardant layers opposite to the support layer is provided with a plurality of first ribs extending in a first direction are formed by injection molding.

In an embodiment, the fire retardant layer in which the plurality of first ribs are formed is further provided with a plurality of second ribs extending in a second direction orthogonal to the first direction and formed by injection molding, and wherein the plurality of first ribs and the plurality of second ribs are staggered and connected to each other.

In an embodiment, one side of at least one of the two fire retardant layers opposite to the support layer is provided with a plurality of screw posts formed by injection molding.

The present invention will become clearer in light of the following detailed description of illustrative embodiments of this invention described in connection with the drawings.

### BRIEF DESCRIPTION OF THE DRAWINGS

FIG. 1 is an exploded perspective view of a multilayer fire extension resistant and fire protection structure manufactured by injection molding of a first embodiment according to the present invention.

FIG. 2 is a cross-sectioned views of the multilayer fire extension resistant and fire protection structure manufactured by injection molding of FIG. 1.

FIG. 3 is an exploded perspective view of a multilayer fire extension resistant and fire protection structure manufactured by injection molding of a second embodiment according to the present invention.

FIG. 4 is an exploded perspective view of a multilayer fire extension resistant and fire protection structure manufactured by injection molding of a third embodiment according to the present invention.

FIG. 5 is an exploded perspective view of a multilayer fire extension resistant and fire protection structure manufactured by injection molding of a fourth embodiment according to the present invention.

### DETAILED DESCRIPTION

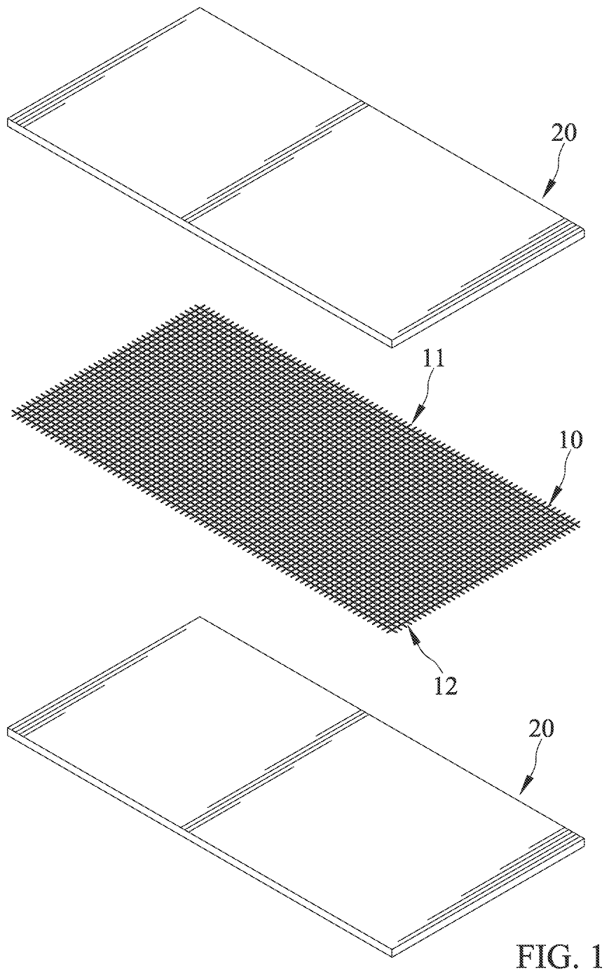

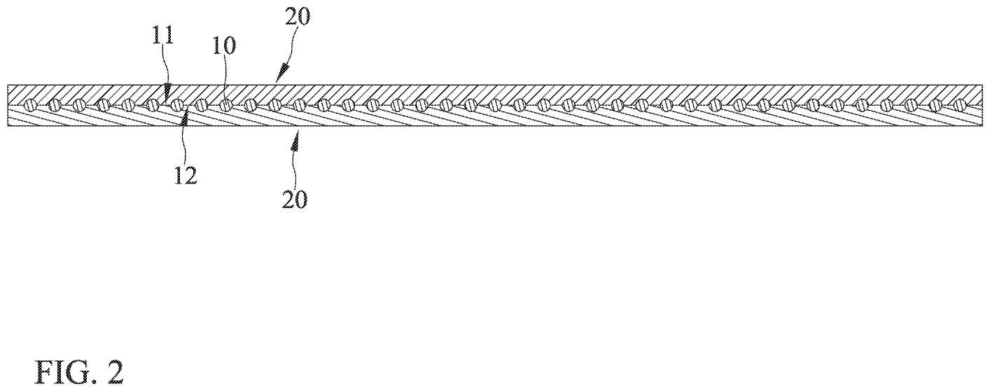

FIGS. 1 and 2 show a multilayer fire extension resistant and fire protection structure manufactured by injection molding of a first embodiment according to the present invention. The multilayer fire extension resistant and fire protection structure includes a support layer 10 and at least two fire retardant layers 20.

The support layer 10 is formed of a porous fiber fabric and has a first face 11 and a second face 12 opposite to the first face 11. The porous fiber fabric may be at least one or a combination selected from the group comprising: a staple fiber cloth, a long fiber cloth, a woven fiber cloth, a nonwoven cloth, a unidirectional fiber cloth, and a multiaxial multilayer fabric. Further, the porous fiber fabric may have a mesh number of 100-5000. Furthermore, the porous fiber fabric may be formed of at least one or a combination selected from the group comprising: a graphite fiber, a graphene fiber, a carbon fiber, a glass fiber, a ceramic fiber, a boron nitrogen fiber, a silicon nitride fiber, a mineral salt fiber, an aromatic polyamide fiber, and an aramid synthetic fiber.

The two fire retardant layers 20 each are formed of a thermoplastic fire retardant polymer material, and the two fire retardant layers 20 are injection molded to respectively cover at least the first face 11 and the second face 12 of the support layer 10. In the embodiment, one of the two fire retardant layers 20 may be covered on the first face 11 of the support layer 10 through a polymer injection molding, and the other fire retardant layer 20 may be covered on the second face 12 of the support layer 10 through the polymer injection molding, that is, the two fire retardant layers 20 are respectively located on two opposite sides of the support layer 10, and then are cross-linked to form a sandwich multilayer structure as shown in FIG. 2, and the two fire retardant layers 20 are formed of the thermoplastic fire retardant polymer material, so it can be effectively recovered and recycled.

The thermoplastic fire retardant polymer material may be a semi-crystalline thermoplastic polymer composite or a non-crystalline thermoplastic polymer composite. Further, the thermoplastic fire retardant polymer material may comprise: 25-45% weight percent of a polyamide; 0.1-2.0% weight percent of a lubricant; 0.1-2.0% weight percent of an antioxidant; 0.1-2.0% weight percent of a surfactant; 0.1-20% weight percent of a toughener; 5-40% weight percent of a nontoxic fire retardant; 10-45% weight percent of a reinforcement modifier; and 0-20% weight percent of a reinforcing material. Furthermore, the polyamide may be nylon-6, nylon-66 or the combination thereof. The nontoxic flame retardant may be polyphosphate metal salts, melamine phosphates, melamine cyanurate, phosphate esters, borates or their mixtures. The reinforcement modifier may be the metal oxides and their derivatives, the metal hydroxides and their derivatives, or metal silicates. The reinforcing material may be the glass fiber, the mineral fiber or the kaolin

Since the thermoplastic fire retardant polymer material has a fire-proof effect that is not inferior to that of inorganic compounds, and satisfies the standard of UL94/5VA. Thus, the two fire retardant layers 20 formed of the thermoplastic fire retardant polymer material are respectively located on two opposite sides of the support layer 10 can effectively achieve the purpose of fire protection regardless of whether the fire source is located on either side of the multilayer fire extension resistant and fire protection structure.

Further, the two fire retardant layers 20 formed of the thermoplastic fire retardant polymer material not only satisfies the standard of UL94/5VA, but also can withstand the flame at a high temperature of 1000° C. directly to be burned without being penetrated by the flame. After being burned by the flame, a carbonized layer structure is generated on one of the two fire retardant layers 20 that be burned, and the carbonized layer can further effectively block the flame. The support layer 10 located in the middle of the sandwich multilayer structure can provide the structural strength, so that the multilayer fire extension resistant and fire protection structure can still maintain a complete structure under burning. The fire retardant layer 20 on the other side will not be penetrated by the flame, and will not generate the carbonized layer structure.

Furthermore, The two fire retardant layers 20 are injection molded to cover the first face 11 and the second face 112 of the support layer 10, respectively, so that the first face 11 and the second face 12 can be formed into complex shapes more than the traditional hot press molding that only forms a sheet.

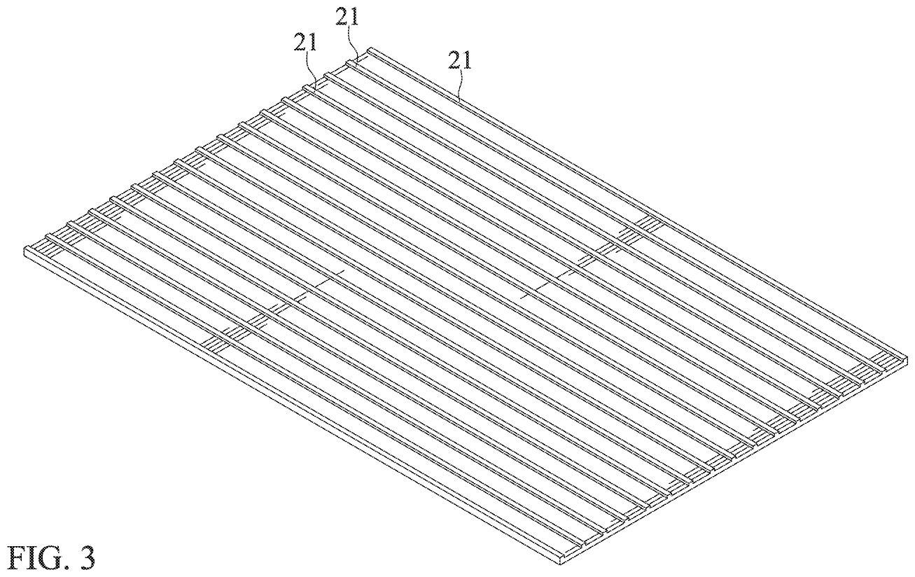

FIG. 3 shows a multilayer fire extension resistant and fire protection structure manufactured by injection molding in accordance with a second embodiment of the present invention. The second embodiment is substantially the same as the first embodiment but is mainly different from the second embodiment by that one side of at least one of the two fire retardant layers 20 opposite to the support layer 10 is provided with a plurality of first ribs 21 extending in a first direction are formed by injection molding. Thus, one of the two fire retardant layers 20 is not only covered on the support layer 10 through the polymer injection molding, but also has several first ribs 21 formed on one side opposite to the support layer 10. In this embodiment, the first direction can be a length direction of the multilayer fire extension resistant and fire protection structure, and the plurality of first ribs 21 extend parallel to each other.

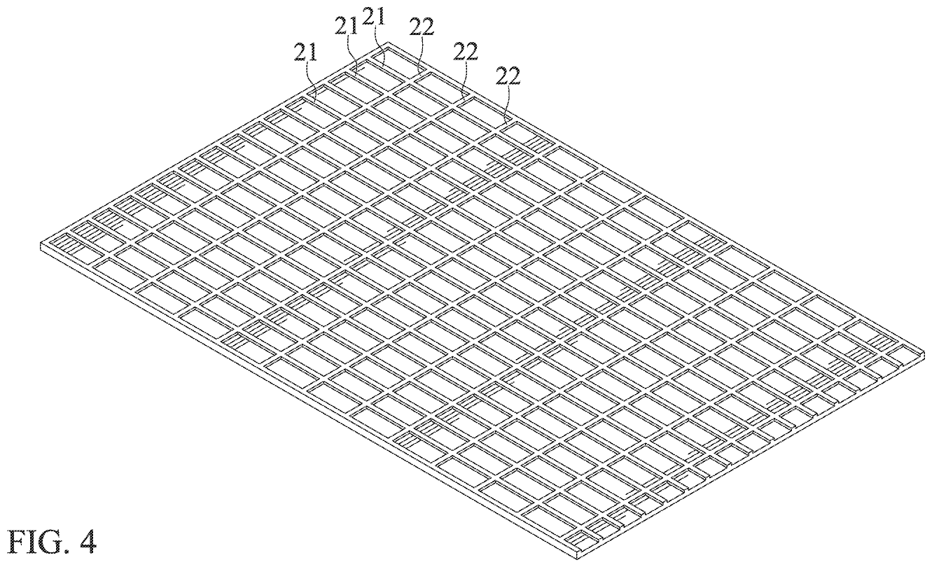

FIG. 4 shows a multilayer fire extension resistant and fire protection structure manufactured by injection molding in accordance with a third embodiment of the present invention. The third embodiment is substantially the same as the second embodiment but is mainly different from the second embodiment by that the fire retardant layer 20 in which the plurality of first ribs 21 are formed is further provided with a plurality of second ribs 22 extending in a second direction orthogonal to the first direction and formed by injection molding, and the plurality of first ribs 21 and the plurality of second ribs 22 are staggered and connected to each other. In this embodiment, the second direction can be a width direction of the multilayer fire extension resistant and fire protection structure, and the plurality of first ribs 21 extend parallel to each other. Thus, the plurality of second ribs 22 extend parallel to each other to form a lattice structure with the plurality of first ribs 21, so that the plurality of first ribs 21 and the plurality of second ribs 22 are beneficial to the improvement of the structural strength and thus the strength of the protection.

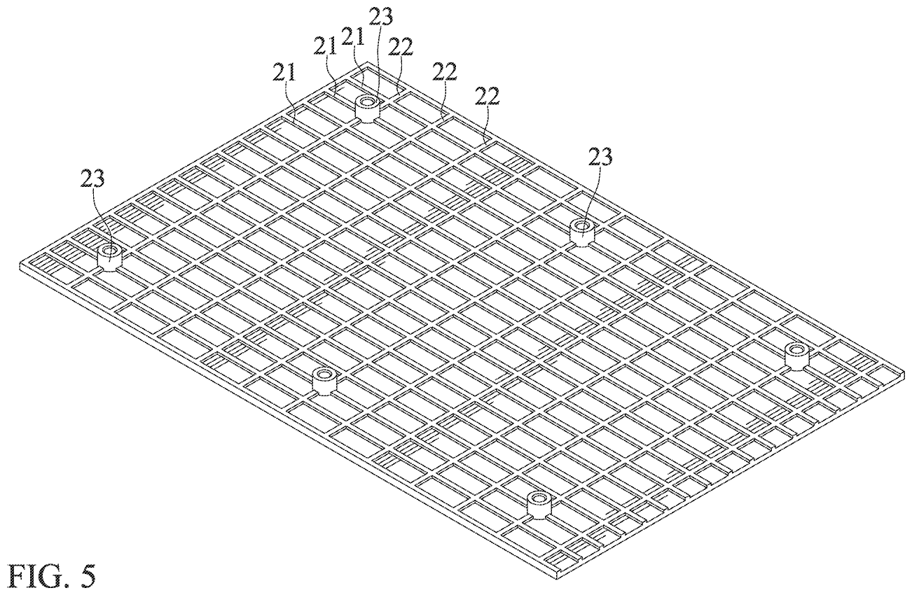

FIG. 5 shows a multilayer fire extension resistant and fire protection structure manufactured by injection molding in accordance with a fourth embodiment of the present invention. The fourth embodiment is substantially the same as the third embodiment but is mainly different from the second embodiment by that one side of at least one of the two fire retardant layers 20 formed with the plurality of first ribs 21 and the plurality of second ribs 22 is further provided with a plurality of screw posts 23 formed by injection molding. In this embodiment, the plurality of screw posts 23 may be formed at some of the staggered connections between the to plurality of first ribs 21 and the plurality of second ribs 22. Thus, the plurality of screw posts 23 is used for the assembly and combination of the multilayer fire extension resistant and fire protection structure with other structural parts or elements.

Although specific embodiments have been illustrated and described, numerous modifications and variations are still possible without departing from the scope of the invention. The scope of the invention is limited by the accompanying claims.

1. A multilayer fire extension resistant and fire protection structure manufactured by injection molding comprising:
a support layer formed of a porous fiber fabric and having a first face and a second face opposite to the first face; and
two fire retardant layers each formed of a thermoplastic fire retardant polymer material, and wherein the two fire retardant layers are injection molded to respectively cover at least the first face and the second face of the support layer.

2. The multilayer fire extension resistant and fire protection structure manufactured by injection molding as claimed in claim 1, wherein the thermoplastic fire retardant polymer material is a semi-crystalline thermoplastic polymer composite or a non-crystalline thermoplastic polymer composite.

3. The multilayer fire extension resistant and fire protection structure manufactured by injection molding as claimed in claim 1, wherein the porous fiber fabric is at least one or a combination selected from the group comprising: a staple fiber cloth, a long fiber cloth, a woven fiber cloth, a non-woven cloth, a unidirectional fiber cloth, and a multiaxial multilayer fabric,

4. The multilayer fire extension resistant and fire protection structure manufactured by injection molding as claimed in claim 1, wherein the porous fiber fabric has a mesh number of 100-5000.

5. The multilayer fire extension resistant and fire protection structure manufactured by injection molding as claimed in claim 1, wherein the porous fiber fabric is formed of at least one or a combination selected from the group comprising: a graphite fiber, a graphene fiber, a carbon fiber, a glass fiber, a ceramic fiber, a boron nitrogen fiber, a silicon nitride fiber, a mineral salt fiber, an aromatic polyamide fiber, and an aramid synthetic fiber.

6. The multilayer fire extension resistant and fire protection structure manufactured by injection molding as claimed in claim 1, wherein to the thermoplastic fire retardant polymer material comprises:
25-45% weight percent of a polyamide;
0.1-2.0% weight percent of a lubricant;
0.1-2.0% weight percent of an antioxidant;
0.1-2.0% weight percent of a surfactant;
0.1-20% weight percent of a toughener;
5-40% weight percent of a nontoxic fire retardant;
10-45% weight percent of a reinforcement modifier; and
0-20% weight percent of a reinforcing material.

7. The multilayer fire extension resistant and fire protection structure manufactured by injection molding as claimed in claim 1, which satisfies the standard of UL94/5VA,

8. The multilayer fire extension resistant and fire protection structure manufactured by injection molding as claimed in claim 1, wherein one side of at least one of the two fire retardant layers opposite to the support layer is provided with a plurality of first ribs extending in a first direction are formed by injection molding.

9. The multilayer fire extension resistant and fire protection structure manufactured by injection molding as claimed in claim 8, wherein the fire retardant layer in which the plurality of first ribs are formed is further provided with a plurality of second ribs extending in a second direction orthogonal to the first direction and formed by injection molding, and wherein the plurality of first ribs and the plurality of second ribs are staggered and connected to each other.

10. The multilayer fire extension resistant and fire protection structure manufactured by injection molding as claimed in claim 1, wherein one side of at least one of the two fire retardant layers opposite to the support layer is provided with a plurality of screw posts formed by injection molding.
